(19) United States
(12) Patent Application Publication
(10) Pub. No.: US 2026/0235097 A1
(43) Pub. Date: Aug. 13, 2026

(54) Two-Member Fixing Structure and High-Pressure Fuel Supply Pump

(71) Applicant: Astemo, Ltd., Chiyoda-ku, Tokyo (JP)

(72) Inventors: Satoshi USUI, Hitachinaka-shi, Ibaraki (JP); Minoru HASHIDA, Hitachinaka-shi, Ibaraki (JP)

(21) Appl. No.: 19/471,086

(22) PCT Filed: May 8, 2023
(86) PCT No.: PCT/JP2023/017278

§ 371 Date: Sep. 30, 2025

(51) Int. Cl. F02M 59/48; F04B 53/16

(52) U.S. Cl. CPC F02M 59/48; F04B 53/168; F02M 2200/8053; F02M 2200/8061

(57) ABSTRACT

The present invention is provided to make stress generated between fixing portions of two members smaller than or equal to a fatigue limit without increasing sizes of parts or increasing the processing difficulty. In a two-member fixing structure of the present invention, a second member 6 includes a curved surface portion 6d with one end 6a1 of an outer circumferential surface 6a in a direction along a center line 1A as a start point 6d1. The first member 1 includes a pressed surface 1g formed by pressing a peripheral edge portion 1c2 of an inner circumferential surface 1c1 , and a plastically deformed portion 1x1 plastically deformed radially inward of the outer circumferential surface 6a of the second member 6. A circle C1 intersects with the curved surface portion 6d, when the circle C1 is drawn with a radius being a length R1 of a line segment LS1 connecting the start point 6d1 and a radially outer end point 1g1 of the pressed surface 1g, while the radially outer end point 1g1 of the pressed surface 1g is the center of the circle C1. An angle θ1 formed between a tangent line LS2 that is in contact with the curved surface portion 6d at an intersection point CP between the circle C1 and the curved surface portion 6d and a line LS3 perpendicular to the center line 1A is larger than 0°.

### TECHNICAL FIELD

The present invention relates to a two-member fixing structure and a high-pressure fuel supply pump that supplies fuel to an engine at a high pressure using the fixing structure.

### BACKGROUND ART

PTL 1 describes a high-pressure fuel supply pump including a pump body in which a pressurizing chamber is formed, and a cylinder inserted into a hole formed in the pump body and formed in a tubular shape. The high-pressure fuel supply pump includes a protruding portion protruding toward the cylinder, the protruding portion being formed from an outer peripheral side to an inner peripheral side with respect to an inner circumferential surface facing an outer circumferential surface of the cylinder at an end of the pump body on a side opposite to the pressurizing chamber. The protruding portion is formed so as to protrude from a flat portion at the end of the pump body on the side opposite to the pressurizing chamber, and the protruding portion supports the cylinder from the side opposite to the pressurizing chamber (see abstract).

### CITATION LIST

### Patent Literature

PTL 1: JP 2019-90425 A

### SUMMARY OF INVENTION

### Technical Problem

In recent years, the system fuel pressure tends to increase (for example, 50 MPa), and the pressure inside the pressurizing chamber of the high-pressure fuel pump also tends to increase. The high-pressure fuel supply pump described in PTL 1 has a problem that large stress is generated in a contact portion between the protruding portion and the cylinder by a load generated by the pressure in the pressurizing chamber. To counter this stress, the size of the support portion (fixing portion) of the cylinder can be increased, thereby preventing the fatigue fracture of the fixing portion. However, the increase in size of the fixing portion leads to an increase in size of the part and an increase in difficulty in processing the fixing portion.

An object of the present invention is to make stress generated between fixing portions of two members smaller than or equal to a fatigue limit without increasing sizes of parts or increasing the processing difficulty.

### Solution to Problem

In order to achieve the above-mentioned object, a two-member fixing structure of the present invention is a two-member fixing structure that fixes a first member having a cylindrical inner circumferential surface and a second member having a cylindrical outer circumferential surface, in which
the second member includes a curved surface portion at one end of the outer circumferential surface in a direction along a center line, the curved surface portion being formed by a curved surface of which a diameter reduces so as to be convex outward in a radial direction as being away from the outer circumferential surface along the center line with the one end of the outer circumferential surface as a start point,
in a state where the second member is fixed to the inner circumferential surface of the first member, the first member includes a pressed surface formed by pressing a peripheral edge portion of the inner circumferential surface of the first member, and a plastically deformed portion plastically deformed inward of the outer circumferential surface of the second member in the radial direction,
a circle intersects with the curved surface portion, when the circle is drawn with a radius being a length of a line segment connecting the start point of the curved surface portion and a radially outer end point of the pressed surface of the first member, while the radially outer end point of the pressed surface is the center of the circle, and
an angle formed between a tangent line that is in contact with the curved surface portion at an intersection point between the circle and the curved surface portion and a line perpendicular to the center line is larger than 0°.

In order to achieve the above-mentioned object, a two-member fixing structure of the present invention is a two-member fixing structure that fixes a first member having a cylindrical inner circumferential surface and a second member having a cylindrical outer circumferential surface, in which
the second member includes a curved surface portion at one end of the outer circumferential surface in a direction along a center line, the curved surface portion being formed by a curved surface of which a diameter reduces so as to be convex outward in a radial direction being away from the outer circumferential surface along the center line with the one end of the outer circumferential surface as a start point,
in a state where the second member is fixed to the inner circumferential surface of the first member, the first member includes a pressed surface formed by pressing a peripheral edge portion of the inner circumferential surface of the first member, and a plastically deformed portion plastically deformed inward of the outer circumferential surface of the second member in the radial direction, and
an angle formed by a line segment connecting the center of a radius of the curved surface portion and the radially outer end point of the pressed surface of the first member and a line perpendicular to the center line is set to be smaller than 0°.

### Advantageous Effects of Invention

According to the present invention, stress generated in the contact portion between the plastically deformed portion of the first member and the curved surface portion of the second member, that is, between the fixing portions of the two members, can be made smaller than or equal to the fatigue limit.

Problems, configurations, and effects other than those described above will become apparent from the following description of embodiments.

### BRIEF DESCRIPTION OF DRAWINGS

FIG. 1 is an overall configuration diagram of a fuel supply system using a high-pressure fuel supply pump according to an embodiment of the present invention.

FIG. 2 is a longitudinal cross-sectional view (part 1) of a high-pressure fuel supply pump according to an embodiment of the present invention.

FIG. 3 is a longitudinal cross-sectional view (part 2) of a high-pressure fuel supply pump according to an embodiment of the present invention.

FIG. 4 is a horizontal cross-sectional view of a high-pressure fuel supply pump according to an embodiment of the present invention as viewed from above.

FIG. 5 is a longitudinal cross-sectional view (part 3) of a high-pressure fuel supply pump according to an embodiment of the present invention.

FIG. 6 is an enlarged view of a cylinder portion before plastic deformation of a high-pressure fuel supply pump according to an embodiment of the present invention.

FIG. 7 is an enlarged view of a cylinder portion after plastic deformation of a high-pressure fuel supply pump according to an embodiment of the present invention.

FIG. 8 is an enlarged view of a protruding portion after plastic deformation of a high-pressure fuel supply pump according to an embodiment of the present invention.

FIG. 9 is an enlarged view in which the vicinity of the plastically deformed portion in FIG. 8 is enlarged.

FIG. 10 is a diagram for explaining a relationship at an intersection point between a circle with its center being a radially outer end point of a pressed surface and a curved surface portion according to an embodiment of the present invention.

FIG. 11 is a conceptual view illustrating a two-member fixing structure according to an embodiment of the present invention.

### DESCRIPTION OF EMBODIMENTS

### 1. Embodiment

Hereinafter, a high-pressure fuel supply pump according to an embodiment of the present invention will be described. In the drawings, the same members are denoted by the same reference signs. Hereinafter, the high-pressure fuel supply pump may be referred to as a fuel pump.

### Fuel Supply System

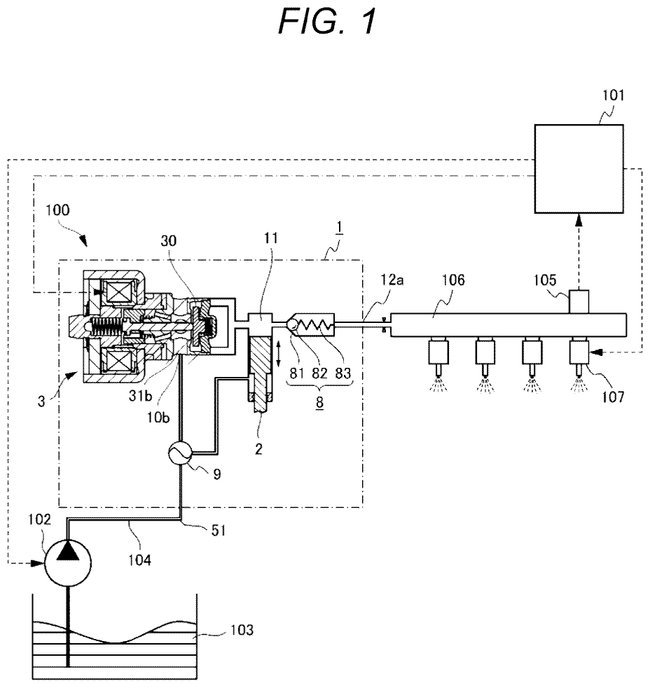

Next, a fuel supply system using the high-pressure fuel supply pump according to the present embodiment will be described with reference to FIG. 1.

FIG. 1 is an overall configuration diagram of a fuel supply system using the high-pressure fuel supply pump according to the present embodiment.
As illustrated in FIG. 1, the fuel supply system includes a high-pressure fuel supply pump 100, an engine control unit (ECU) 101, a fuel tank 103, a common rail 106, and a plurality of injectors 107. The components of the high-pressure fuel supply pump 100 are integrally incorporated in a pump body 1.

A fuel in the fuel tank 103 is pumped up by a feed pump 102 that is driven based on a signal from the ECU 101. The pumped-up fuel is pressurized to an appropriate pressure by a pressure regulator (not illustrated) and sent to a low-pressure fuel suction port 51 of the high-pressure fuel supply pump 100 through a low-pressure pipe 104.

The high-pressure fuel supply pump 100 pressurizes the fuel supplied from the fuel tank 103 and pumps the fuel to the common rail 106. The plurality of injectors 107 and a fuel pressure sensor 105 are mounted on the common rail 106. The plurality of injectors 107 are mounted in accordance with the number of cylinders (combustion chambers), and inject the fuel according to a drive current output from the ECU 101. The fuel supply system of the present embodiment is a so-called direct injection engine system in which the injectors 107 directly inject the fuel into the cylinders of the engine.

The fuel pressure sensor 105 outputs detected pressure data to the ECU 101. The ECU 101 calculates an appropriate fuel injection amount (target fuel injection duration), an appropriate fuel pressure (target fuel pressure), and the like based on engine state quantities (e.g., a crank rotation angle, a throttle opening, an engine speed, a fuel pressure, and the like) obtained from various sensors.

In addition, the ECU 101 controls the driving of the high-pressure fuel supply pump 100 and the plurality of injectors 107 based on results of calculating the fuel pressure (target fuel pressure) and the like. That is, the ECU 101 includes a pump control unit that controls the high-pressure fuel supply pump 100 and an injector control unit that controls the injectors 107.

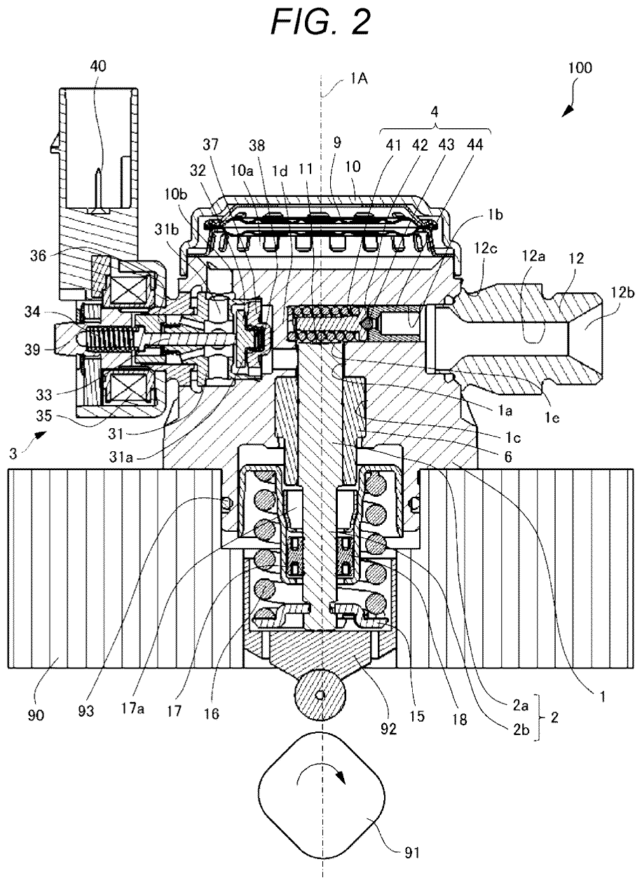

The high-pressure fuel supply pump 100 includes a pressure pulsation reduction mechanism 9, an electromagnetic suction valve 3 which is a variable capacity mechanism, a relief valve 4 (see FIG. 2), and a discharge valve 8. The fuel flowing from the low-pressure fuel suction port 51 reaches a suction port 31b of the electromagnetic suction valve 3 via a pressure pulsation reduction mechanism 9 and a suction passage 10b.

The fuel flowing into the electromagnetic suction valve 3 passes through a valve portion 32, flows through a suction passage 1d formed in the pump body 1, and then flows into a pressurizing chamber 11. A plunger 2 is reciprocably inserted into the pressurizing chamber 11. The plunger 2 reciprocates by power transmitted by a cam 91 (see FIG. 2) of the engine.

In the pressurizing chamber 11, the fuel is sucked from the electromagnetic suction valve 3 during a downward stroke of the plunger 2, and the fuel is pressurized during an upward stroke. When the fuel pressure in the pressurizing chamber 11 exceeds a predetermined value, the discharge valve 8 is opened, and the high-pressure fuel is pumped to the common rail 106 via a discharge passage 12a. The discharge of the fuel by the high-pressure fuel supply pump 100 is operated by opening and closing the electromagnetic suction valve 3. The opening and closing of the electromagnetic suction valve 3 is controlled by the ECU 101.

### High-Pressure Fuel Supply Pump

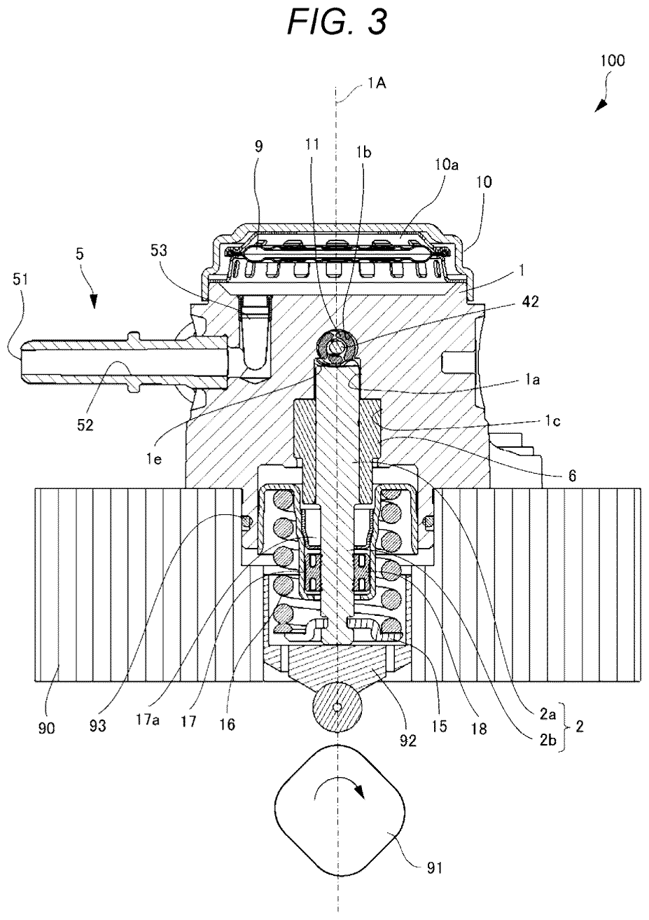

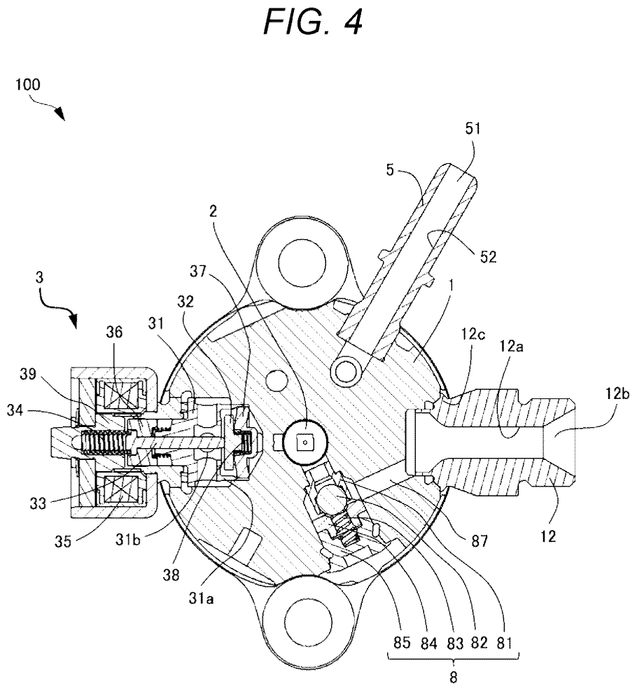

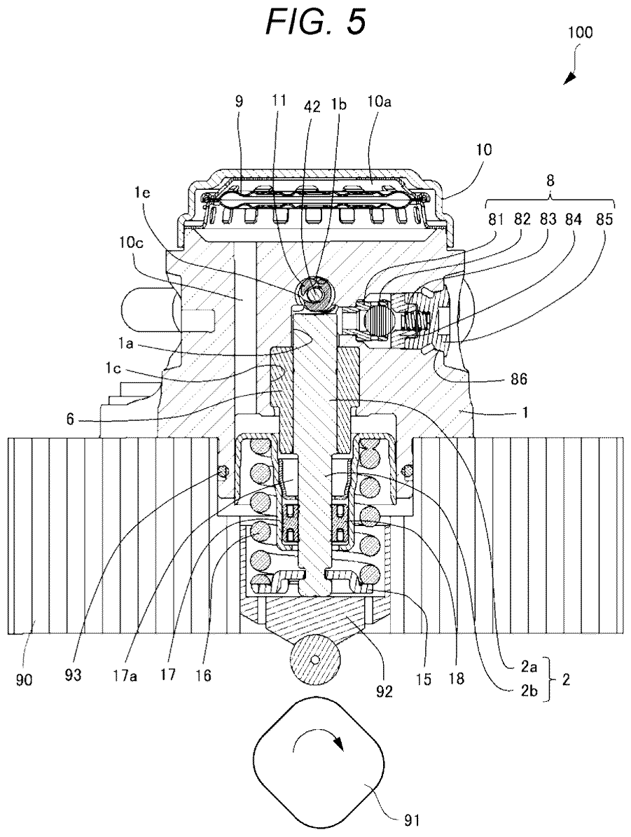

Next, a configuration of the high-pressure fuel supply pump 100 will be described with reference to FIGS. 2 to 5.
FIG. 2 is a longitudinal cross-sectional view (part 1) of the high-pressure fuel supply pump 100 as viewed in a cross section perpendicular to the horizontal direction. FIG. 3 is a longitudinal cross-sectional view (part 2) of the high-pressure fuel supply pump 100 as viewed in a cross section perpendicular to the horizontal direction. FIG. 4 is a horizontal cross-sectional view of the high-pressure fuel supply pump 100 as viewed in a cross section perpendicular to the vertical direction. FIG. 5 is a longitudinal cross-sectional view (part 3) of the high-pressure fuel supply pump 100 as viewed in a cross section perpendicular to the horizontal direction.

As illustrated in FIGS. 2 to 5, the pump body 1 of the high-pressure fuel supply pump 100 is formed in a substantially columnar shape. As illustrated in FIGS. 2 and 3, the pump body 1 includes a first chamber 1a, a second chamber 1b, a third chamber 1c, and a suction passage 1d. The pump body 1 is in close contact with a fuel pump attachment portion 90 and is fixed thereto by a plurality of bolts (screws) (not illustrated).

The first chamber la is a columnar space provided in the pump body 1, and a center line 1A of the first chamber 1a coincides with a center line of the pump body 1. One end portion of the plunger 2 is inserted into the first chamber 1a, and the plunger 2 reciprocates in the first chamber 1a. The first chamber 1a and one end of the plunger 2 form the pressurizing chamber 11.

The second chamber 1b is a columnar space provided in the pump body 1, and a center line of the second chamber 1b is perpendicular to the center line of the pump body 1 (first chamber 1a). The relief valve 4 is disposed in the second chamber 1b. The second chamber 1b has a smaller diameter than the first chamber 1a.

The first chamber la and the second chamber 1b communicate with each other through a circular communication hole 1e. The communication hole 1e has the same diameter as the first chamber 1a, and the communication hole 1e extends one end of the first chamber 1a. The communication hole 1e has a diameter larger than an outer diameter of the plunger 2. A center line of the communication hole 1e is perpendicular to the center line of the second chamber 1b.

As illustrated in FIGS. 3 and 5, the diameter of the communication hole 1e is larger than the diameter of the second chamber 1b. This makes it possible to smoothly return, to the pressurizing chamber 11, the fuel that has passed through the relief valve 4 disposed in the second chamber 1b.

The third chamber 1c is a columnar space provided in the pump body 1, and is continuous with the other end of the first chamber 1a. A center line of the third chamber 1c coincides with the center line 1A of the first chamber 1a and the center line of the pump body 1, and the third chamber 1c has a larger diameter than the first chamber 1a. A cylinder 6 that guides the reciprocation of the plunger 2 is disposed in the third chamber 1c.

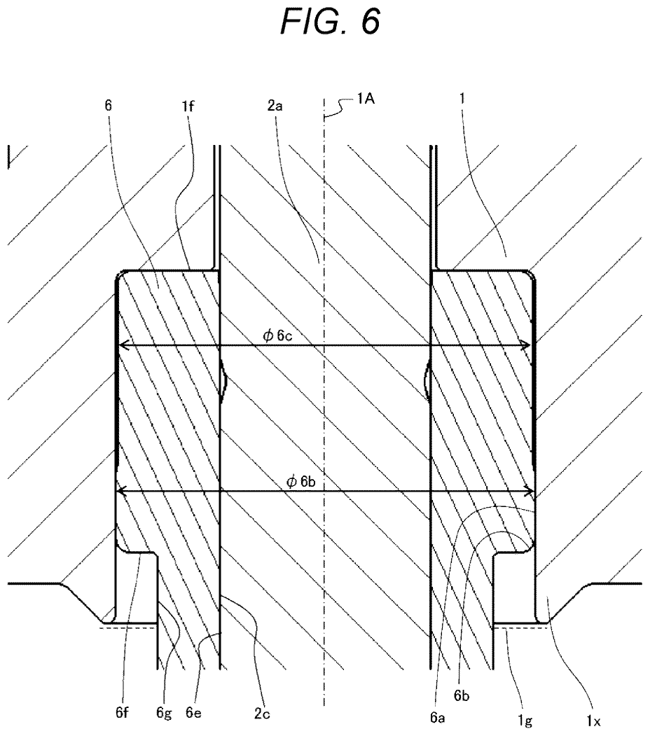

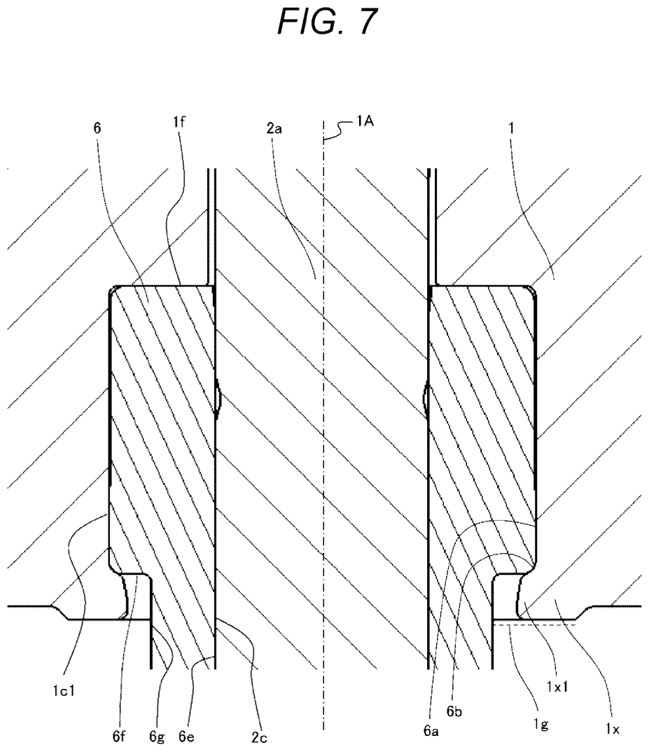

This will be described with reference to FIGS. 6 and 7. FIG. 6 is an enlarged view of a cylinder portion before plastic deformation of the high-pressure fuel supply pump 100 according to an embodiment of the present invention. FIG. 7 is an enlarged view of a cylinder portion after being plastically deformed of the high-pressure fuel supply pump 100 according to an embodiment of the present invention.

The cylinder 6 is formed in a tubular shape, and its inner circumferential surface 6e has a cylindrical shape. The plunger 2 having a cylindrical outer circumferential surface 2c is inserted into the inner circumferential surface 6e. The cylinder 6 has a cylindrical outer circumferential surface 6a serving as a press-fitting portion and a surface (radial surface) 6f extending along the radial direction. The cylinder 6 has a small-diameter portion 6g having a smaller diameter than the outer circumferential surface 6a, and the radial surface 6f is provided between the outer circumferential surface 6a and the small-diameter portion 6g to connect the outer circumferential surface 6a and the small-diameter portion 6g.

The cylinder 6 is press-fitted into the third chamber 1c of the pump body 1 at the press-fitting portion 6a on an outer circumferential side thereof, and one end of the cylinder 6 abuts on a top surface (a step portion between the first chamber la and the third chamber 1c) 1f of the third chamber 1c. In the cylinder, only the press-fitting portion 6a has a press-fitting dimension, and a diameter 06c on the pressurizing chamber 11 side of the press-fitting portion 6a is set to be smaller than the diameter 06a of the press-fitting portion 6a. Therefore, there is a clearance between the cylinder and the third chamber 1c. The plunger 2 is in slidable contact with the inner circumferential surface of the cylinder 6.

FIG. 6 illustrates a state immediately after the cylinder 6 is press-fitted into the third chamber 1c. One end of the cylinder 6 is in contact with the top surface of the third chamber 1c. In this state, a load of several hundred kN is applied to a pressing portion 1y to deform a protruding portion 1x. FIG. 7 illustrates a shape after the protruding portion 1x has been deformed. The protruding portion 1x is deformed so as to cover a cylinder corner portion 6b when the pressing portion 1y receives a load. That is, a plastically deformed portion 1x1 is formed in the protruding portion 1x, and the cylinder 6 is prevented from falling off from the third chamber 1c by the press-fitting portion 6a and the plastically deformed portion 1x1 of the protruding portion 1x.

Here, the cylinder corner portion 6b has an R shape. Instead of the R shape, the cylinder corner portion 6b may be shaped to smoothly connect the press-fitting portion (outer circumferential surface) 6a and the radial surface 6f, and have no discontinuous point in a region in contact with the protruding portion 1x. Although details will be described later, this is to suppress the stress generated in the protruding portion to be smaller than or equal to the fatigue limit when the pressure in the pressurizing chamber 11 becomes high and a pull-out load is generated in the cylinder 6.

Referring back to FIGS. 2 to 5, the description will be given. An O-ring 93, which is a specific example of a seat member, is interposed between the fuel pump attachment portion 90 and the pump body 1. The O-ring 93 prevents engine oil from leaking to the outside of the engine (internal combustion engine) through a gap between the fuel pump attachment portion 90 and the pump body 1.

A tappet 92 is provided at a lower end of the plunger 2 to convert a rotational motion of a cam 91 attached to a cam shaft of the engine into a vertical motion to transmit the vertical motion to the plunger 2. The plunger 2 is biased toward the cam 91 by a spring 16 via a retainer 15, and is pressed against the tappet 92. The tappet 92 reciprocates as the cam 91 rotates. The plunger 2 reciprocates together with the tappet 92 to change the volume of the pressurizing chamber 11.

A seal holder 17 is disposed between the cylinder 6 and the retainer 15. The seal holder 17 is formed in a tubular shape into which the plunger 2 is inserted, and has an auxiliary chamber 17a at an upper end portion on the cylinder 6 side. In addition, the seal holder 17 holds a plunger seal 18 at a lower end portion on the retainer 15 side.

The plunger seal 18 is slidably in contact with an outer circumference of the plunger 2. The plunger seal 18 seals the fuel in the auxiliary chamber 17a when the plunger 2 reciprocates. This prevents the fuel in the auxiliary chamber 17a from flowing into the engine. In addition, the plunger seal 18 prevents lubricating oil (including engine oil) that lubricates a sliding portion in the engine from flowing into the pump body 1.

In FIG. 2, the plunger 2 reciprocates in the up-down direction. When the plunger 2 descends, the volume of the pressurizing chamber 11 increases, and when the plunger 2 ascends, the volume of the pressurizing chamber 11 decreases. That is, the plunger 2 is disposed to reciprocate in a direction in which the volume of the pressurizing chamber 11 is increased and decreased.

The plunger 2 has a large-diameter portion 2a and a small-diameter portion 2b. When the plunger 2 reciprocates, the large-diameter portion 2a and the small-diameter portion 2b are located in the auxiliary chamber 17a. Therefore, the volume of the auxiliary chamber 17a increases or decreases as the plunger 2 reciprocates.

The auxiliary chamber 17a communicates with a low-pressure fuel chamber 10 through a fuel passage 10c (see FIG. 5). When the plunger 2 descends, the fuel flows from the auxiliary chamber 17a to the low-pressure fuel chamber 10, and when the plunger 2 ascends, the fuel flows from the low-pressure fuel chamber 10 to the auxiliary chamber 17a. This makes it possible to reduce the amount of the fuel flowing into or out of the pump during a suction stroke or a return stroke of the high-pressure fuel supply pump 100. This makes it possible to reduce the pressure pulsation generated in the high-pressure fuel supply pump 100.

As illustrated in FIG. 3, the low-pressure fuel chamber 10 is provided in an upper portion of the pump body 1 of the high-pressure fuel supply pump 100, and a suction joint 5 is attached to a side surface portion of the pump body 1. The suction joint 5 is connected to the low-pressure pipe 104 allowing fuel supplied from the fuel tank 103 (see FIG. 1) to pass therethrough. The fuel in the fuel tank 103 is supplied from the suction joint 5 to the inside of the pump body 1.

The suction joint 5 includes a low-pressure fuel suction port 51 connected to the low-pressure pipe 104 and a suction flow path 52 communicating with the low-pressure fuel suction port 51. The fuel that has passed through the suction flow path 52 passes through a suction filter 53 provided inside the pump body 1, and is supplied to the low-pressure fuel chamber 10. The suction filter 53 removes foreign substances present in the fuel to prevent the foreign substances from entering the high-pressure fuel supply pump 100.

A low-pressure fuel flow path 10a and a suction passage 10b (see FIG. 2) are provided in the low-pressure fuel chamber 10. The pressure pulsation reduction mechanism 9 is provided in the low-pressure fuel flow path 10a. When the fuel having flowed into the pressurizing chamber 11 is returned to the suction passage 10b through the electromagnetic suction valve 3 in the open state again, pressure pulsation occurs in the low-pressure fuel chamber 10. The pressure pulsation reduction mechanism 9 reduces the spreading of the pressure pulsation generated in the high-pressure fuel supply pump 100 to the low-pressure pipe 104.

The pressure pulsation reduction mechanism 9 is formed of a metal diaphragm damper in which two corrugated disk-shaped metal plates are bonded to each other at their outer circumferences with an inert gas such as argon injected inside. The metal diaphragm damper of the pressure pulsation reduction mechanism 9 expands and contracts to absorb or reduce the pressure pulsation.

The suction passage 10b communicates with the suction port 31b (see FIG. 2) of the electromagnetic suction valve 3, and the fuel having passed through the low-pressure fuel flow path 10a reaches the suction port 31b of the electromagnetic suction valve 3 via the suction passage 10b.

As illustrated in FIGS. 2 and 4, the electromagnetic suction valve 3 is inserted into a lateral pit formed in the pump body 1. The electromagnetic suction valve 3 includes a suction valve seat 31 press-fitted into the lateral pit formed in the pump body 1, a valve portion 32, a rod 33, a rod biasing spring 34, an electromagnetic coil 35, and an anchor 36.

The suction valve seat 31 is formed in a tubular shape, and a seating portion 31a is provided on an inner peripheral portion thereof. A suction port 31b that reaches the inner peripheral portion from an outer peripheral portion thereof is formed in the suction valve seat 31. The suction port 31b communicates with the suction passage 10b in the low-pressure fuel chamber 10 described above.

A stopper 37 facing the seating portion 31a of the suction valve seat 31 is disposed in the lateral pit formed in the pump body 1, and the valve portion 32 is disposed between the stopper 37 and the seating portion 31a. In addition, a valve biasing spring 38 is interposed between the stopper 37 and the valve portion 32. The valve biasing spring 38 biases the valve portion 32 toward the seating portion 31a.

When the valve portion 32 abuts on the seating portion 31a, the communicating portion between the suction port 31b and the pressurizing chamber 11 is closed, and the electromagnetic suction valve 3 is brought into a closed state. On the other hand, when the valve portion 32 abuts on the stopper 37, the communicating portion between the suction port 31b and the pressurizing chamber 11 is opened, and the electromagnetic suction valve 3 is brought into an open state.

The rod 33 penetrates the tubular hole of the suction valve seat 31, and one end thereof abuts on the valve portion 32. The rod biasing spring 34 biases the valve portion 32 via the rod 33 in the valve opening direction toward the stopper 37. One end of the rod biasing spring 34 is engaged with the other end of the rod 33, and the other end of the rod biasing spring 34 is engaged with a magnetic core 39 disposed so as to surround the rod biasing spring 34.

The anchor 36 faces an end surface of the magnetic core 39. The anchor 36 is engaged with a flange provided in a middle portion of the rod 33. The electromagnetic coil 35 is disposed once around the magnetic core 39. A terminal member 40 is electrically connected to the electromagnetic coil 35, and a current flows through the terminal member 40.

In a non-energized state in which no current flows through the electromagnetic coil 35, the rod 33 is biased in the valve opening direction by the biasing force of the rod biasing spring 34 to press the valve portion 32 in the valve opening direction. As a result, the valve portion 32 is separated from the seating portion 31a and abuts on the stopper 37, and the electromagnetic suction valve 3 is in the open state. That is, the electromagnetic suction valve 3 is of a normally open type in which valve is open in a non-energized state.

In the open state of the electromagnetic suction valve 3, the fuel in the suction port 31b passes between the valve portion 32 and the seating portion 31a, and flows into the pressurizing chamber 11 through a plurality of fuel passage holes (not illustrated) of the stopper 37 and the suction passage 1d. In the open state of the electromagnetic suction valve 3, the valve portion 32 comes into contact with the stopper 37, and thus the position of the valve portion 32 in the valve opening direction is regulated. A gap existing between the valve portion 32 and the seating portion 31a in the open state of the electromagnetic suction valve 3 is a movable range of the valve portion 32, which is a valve opening stroke.

When a current flows through the electromagnetic coil 35, the anchor 36 is attracted in the valve closing direction by the magnetic attractive force of the magnetic core 39. As a result, the anchor 36 moves against the biasing force of the rod biasing spring 34 and comes into contact with the magnetic core 39. When the anchor 36 moves in the valve closing direction toward the magnetic core 39, the rod 33 with which the anchor 36 is engaged moves together with the anchor 36. As a result, the valve portion 32 is released from the biasing force in the valve opening direction, and moves in the valve closing direction due to the biasing force of the valve biasing spring 38. When the valve portion 32 comes into contact with the seating portion 31a of the suction valve seat 31, the electromagnetic suction valve 3 is brought into a closed state.

As illustrated in FIGS. 4 and 5, the discharge valve 8 is connected to an outlet side (downstream side) of the pressurizing chamber 11. The discharge valve 8 includes a discharge valve seat 81 communicating with the pressurizing chamber 11, a valve portion 82 that comes into contact with and is separated from the discharge valve seat 81, a discharge valve spring 83 that biases the valve portion 82 toward the discharge valve seat 81, and a discharge valve stopper 84 that determines a stroke (moving distance) of the valve portion 82.

In addition, the discharge valve 8 includes a plug 85 that blocks leakage of fuel to the outside. £ The discharge valve stopper 84 is press-fitted into the plug 85. The plug 85 is joined to the pump body 1 by welding at a welded portion 86. The discharge valve 8 communicates with a discharge valve chamber 87 opened and closed by the valve portion 82. The discharge valve chamber 87 is formed in the pump body 1.

A lateral pit communicating with the second chamber 1b (see FIG. 2) is provided in the pump body 1, and a discharge joint 12 is inserted into the lateral pit. The discharge joint 12 includes the above-described discharge passage 12a communicating with the lateral pit of the pump body 1 and the discharge valve chamber 87, and a fuel discharge port 12b, which is one end of the discharge passage 12a. The fuel discharge port 12b of the discharge joint 12 communicates with the common rail 106. The discharge joint 12 is fixed to the pump body 1 by welding at a welded portion 12c.

In a state where there is no difference in fuel pressure (fuel differential pressure) between the pressurizing chamber 11 and the discharge valve chamber 87, the valve portion 82 is pressed against the discharge valve seat 81 by the biasing force of the discharge valve spring 83, and the discharge valve 8 is in a closed state. When the fuel pressure in the pressurizing chamber 11 becomes larger than the fuel pressure in the discharge valve chamber 87, the valve portion 82 moves against the biasing force of the discharge valve spring 83, and the discharge valve 8 is brought into an open state.

When the discharge valve 8 is in the closed state, the (high-pressure) fuel in the pressurizing chamber 11 passes through the discharge valve 8 and reaches the discharge valve chamber 87. Then, the fuel that has reached the discharge valve chamber 87 is discharged to the common rail 106 (see FIG. 1) via the fuel discharge port 12b of the discharge joint 12. With the above-described configuration, the discharge valve 8 functions as a check valve that restricts the flow direction of the fuel.

The relief valve 4 illustrated in FIG. 2 is a valve configured to operate to return the fuel in the discharge passage 12a to the pressurizing chamber 11 when a certain problem occurs in the common rail 106 or a member downstream of the common rail 106 and the pressure in the common rail 106 becomes high beyond a predetermined pressure. The relief valve 4 is disposed at a position higher than the discharge valve 8 (see FIG. 5) in the direction in which the plunger 2 reciprocates (up-down direction).

The relief valve 4 includes a relief spring 41, a relief valve holder 42, a valve portion 43, and a seat member 44. The relief valve 4 is inserted from the discharge joint 12 and disposed in the second chamber 1b. One end portion of the relief spring 41 abuts on the pump body 1 (one end of the second chamber 1b), and the other end portion of the relief spring 41 abuts on the relief valve holder 42. The relief valve holder 42 is engaged with the valve portion 43, and the biasing force of the relief spring 41 acts on the valve portion 43 via the relief valve holder 42.

The valve portion 43 is pressed by the biasing force of the relief spring 41 to close the fuel passage of the seat member 44. A moving direction of the valve portion 43 (relief valve holder 42) is perpendicular to the direction in which the plunger 2 reciprocates. A center line of the relief valve 4 (a center line of the relief valve holder 42) is perpendicular to the center line of the plunger 2.

The seat member 44 has a fuel passage facing the valve portion 43, and a side of the fuel passage opposite to the valve portion 43 communicates with the discharge passage 12a. A movement of the fuel between the pressurizing chamber 11 (upstream side) and the seat member 44 (downstream side) is blocked when the valve portion 43 comes into contact (close contact) with the seat member 44 to close the fuel passage.

When the pressure in the common rail 106 or a member downstream of the common rail 106 increases, the fuel on the seat member 44 side presses the valve portion 43 and moves the valve portion 43 against the biasing force of the relief spring 41. As a result, the valve portion 43 is opened, and the fuel in the discharge passage 12a returns to the pressurizing chamber 11 through the fuel passage of the seat member 44. Therefore, the pressure for opening the valve portion 43 is determined by the biasing force of the relief spring 41.

The moving direction of the valve portion 43 (relief valve holder 42) in the relief valve 4 is different from the moving direction of the valve portion 82 in the discharge valve 8 described above. That is, the moving direction of the valve portion 82 in the discharge valve 8 is a first radial direction of the pump body 1, and the moving direction of the valve portion 43 in the relief valve 4 is a second radial direction different from the first radial direction of the pump body 1. This makes it possible to position the discharge valve 8 and the relief valve 4 so as not to overlap each other in the up-down direction, so that the space inside the pump body 1 can be effectively used to downsize the pump body 1.

### Operation of High-Pressure Fuel Supply Pump

Next, an operation of the high-pressure fuel supply pump according to the present embodiment will be described with reference to FIGS. 2 and 4.

In FIG. 2, when the plunger 2 descends, if the electromagnetic suction valve 3 is opened, the fuel flows from the suction passage 1d into the pressurizing chamber 11. Hereinafter, the stroke in which the plunger 2 descends will be referred to as a suction stroke. On the other hand, when the plunger 2 ascends, if the electromagnetic suction valve 3 is closed, the fuel in the pressurizing chamber 11 is pressurized, passes through the discharge valve 8, and is pumped to the common rail 106 (see FIG. 1). Hereinafter, the stroke in which the plunger 2 ascends will be referred to as an upward stroke.

As described above, when the electromagnetic suction valve 3 is closed during the upward stroke, the fuel sucked into the pressurizing chamber 11 during the suction stroke is pressurized and discharged toward the common rail 106. On the other hand, when the electromagnetic suction valve 3 is opened during the upward stroke, the fuel in the pressurizing chamber 11 is pushed back toward the suction passage 1d and is not discharged toward the common rail 106. In this manner, the discharge of the fuel by the high-pressure fuel supply pump 100 is operated by opening and closing the electromagnetic suction valve 3. The opening and closing of the electromagnetic suction valve 3 is controlled by the ECU 101.

In the suction stroke, the volume of the pressurizing chamber 11 increases, and the fuel pressure in the pressurizing chamber 11 decreases. As a result, the fluid differential pressure between the suction port 31b and the pressurizing chamber 11 (hereinafter, referred to as a “fluid differential pressure before and after the valve portion 32”) decreases. When the biasing force of the rod biasing spring 34 becomes larger than the fluid differential pressure before and after the valve portion 32, the rod 33 moves in the valve opening direction, the valve portion 32 is separated from the seating portion 31a of the suction valve seat 31, and the electromagnetic suction valve 3 is brought into a valve opening state.

When the electromagnetic suction valve 3 is in the open state, the fuel in the suction port 31b passes between the valve portion 32 and the seating portion 31a, and flows into the pressurizing chamber 11 through a plurality of fuel passage holes (not illustrated) of the stopper 37. In the open state of the electromagnetic suction valve 3, the valve portion 32 comes into contact with the stopper 37, and thus the position of the valve portion 32 in the valve opening direction is regulated. A gap existing between the valve portion 32 and the seating portion 31a in the open state of the electromagnetic suction valve 3 is a movable range of the valve portion 32, which is a valve opening stroke.

After the suction stroke is completed, the flow proceeds to the upward stroke. At this time, the electromagnetic coil 35 remains in the non-energized state, and no magnetic attractive force acts between the anchor 36 and the magnetic core 39. A biasing force in the valve opening direction according to a difference in biasing force between the rod biasing spring 34 and the valve biasing spring 38 and a force pressing in the valve closing direction due to a fluid force generated when the fuel flows back from the pressurizing chamber 11 to the low-pressure fuel flow path 10a act on the valve portion 32.

In this state, in order for the electromagnetic suction valve 3 to maintain its open state, the difference in biasing force between the rod biasing spring 34 and the valve biasing spring 38 is set to be larger than the fluid force. The volume of the pressurizing chamber 11 decreases as the plunger 2 ascends. Therefore, the fuel sucked into the pressurizing chamber 11 passes back between the valve portion 32 and the seating portion 31a and is returned to the suction port 31b. As a result, the pressure inside the pressurizing chamber 11 does not increase. This stroke is referred to as a return stroke.

In the return stroke, when a control signal from the ECU 101 (see FIG. 1) is applied to the electromagnetic suction valve 3, a current flows through the electromagnetic coil 35 via the terminal member 40. When a current flows through the electromagnetic coil 35, a magnetic attractive force acts between the magnetic core 39 and the anchor 36, and the anchor 36 (rod 33) is attracted to the magnetic core 39. As a result, the anchor 36 (rod 33) moves in the valve closing direction (the direction away from the valve portion 32) against the biasing force of the rod biasing spring 34.

When the anchor 36 (rod 33) moves in the valve closing direction, the valve portion 32 is released from the biasing force in the valve opening direction, and moves in the valve closing direction due to the biasing force of the valve biasing spring 38 and the fluid force caused by the fuel flowing into the suction passage 10b. When the valve portion 32 comes into contact with the seating portion 31a of the suction valve seat 31 (the valve portion 32 is seated on the seating portion 31a), the electromagnetic suction valve 3 is brought into a closed state.

After the electromagnetic suction valve 3 is brought into the closed state, the fuel in the pressurizing chamber 11 is pressurized as the plunger 2 ascends, and when the pressure of the fuel in the pressurizing chamber 11 becomes higher than or equal to a predetermined pressure, the fuel passes through the discharge valve 8 and is discharged to the common rail 106 (see FIG. 1). This stroke is referred to as a discharge stroke. That is, the upward stroke from the lower start point to the upper start point of the plunger 2 includes a return stroke and a discharge stroke. By controlling the timing of energizing the electromagnetic coil 35 of the electromagnetic suction valve 3, the amount of high-pressure fuel to be discharged can be controlled.

If the electromagnetic coil 35 is energized at an earlier timing, the proportion of the return stroke becomes smaller, and the proportion of the discharge stroke becomes larger during the upward stroke. As a result, the amount of fuel returned to the suction passage 10b decreases, and the amount of fuel discharged at a high pressure increases. On the other hand, if the electromagnetic coil 35 is energized at a later timing, the proportion of the return stroke becomes larger, and the proportion of the discharge stroke becomes smaller during the upward stroke. As a result, the amount of fuel returned to the suction passage 10b increases, and the amount of fuel discharged at a high pressure decreases. As described above, by controlling the timing of energizing the electromagnetic coil 35, the amount of fuel discharged at a high pressure can be controlled to an amount required by the engine (internal combustion engine).

### 2. Summary

As described above, the high-pressure fuel supply pump 100 according to the above-described embodiment includes a pump body 1 (pump body), a plunger 2 (plunger), an electromagnetic suction valve 3 (suction valve), and a relief valve 4 (relief valve). The plunger 2 reciprocates in a first chamber 1a (first chamber) that is a columnar space provided in the pump body 1. The electromagnetic suction valve 3 sucks fuel into a pressurizing chamber 11 (pressurizing chamber) formed by the first chamber 1a and the plunger 2. The relief valve 4 is opened when the fuel pressure on the downstream side of the pressurizing chamber 11 exceeds a set value to return the fuel to the pressurizing chamber 11. The pump body 1 includes a second chamber 1b (second chamber) in which the relief valve 4 is disposed, and a communication hole 1e (communication hole) that allows communication between the first chamber la and the second chamber 1b. The communication hole le has the same diameter as the first chamber 1a.

When holes such as the first chamber la, the second chamber 1b, and the communication hole le are processed in the pump body 1, unnecessary protrusions (burrs) are generated on the processed surface. If the protrusions (burrs) are left, they cause errors in hole dimensions, making it impossible to attach parts and causing injury when the protrusions (burrs) are touched. Therefore, it is necessary to remove the protrusions (burrs). In the embodiment described above, since the diameter of the communication hole le is the same as the diameter of the first chamber 1a, the communication hole le can be easily processed and protrusions (burrs) can be easily removed. In addition, the pump body 1 can be prevented from having a complicated shape. Therefore, the productivity of the pump body 1 and the high-pressure fuel supply pump 100 can be improved, and the cost can be reduced.

In addition, since the diameter of the communication hole 1e is the same as the diameter of the first chamber 1a, the fuel can easily flow from the relief valve 4 to the pressurizing chamber 11, thereby improving the relief performance. Furthermore, since the relief valve is directly incorporated in the second chamber 1b provided in the pump body 1, a housing (seat member) for housing parts constituting the relief valve can be omitted, which reduces the number of parts, thereby reducing the cost.

In the high-pressure fuel supply pump 100 according to the embodiment described above, the second chamber 1b (second chamber) is a columnar space, and the second chamber 1b has a smaller diameter than the communication hole le (communication hole). This makes it possible for the fuel flowing from the relief valve 4 to the pressurizing chamber 11 to easily pass through the communication hole le, thereby improving the relief performance.

In the high-pressure fuel supply pump 100 according to the above-described embodiment, the center line of the communication hole le (communication hole) is perpendicular to the center line of the second chamber 1b (second chamber). This makes it possible for the fuel that has passed through the relief valve 4 disposed in the second chamber 1b to efficiently pass through the communication hole 1e, not hindering improvement in relief performance. In addition, the pump body 1 can be prevented from having a complicated shape, thereby improving the productivity of the pump body 1 and the high-pressure fuel supply pump 100.

In the high-pressure fuel supply pump 100 according to the above-described embodiment, the diameter of the communication hole 1e (communication hole) is larger than the outer diameter of the plunger 2 (plunger). As a result, the plunger 2 reciprocating in the pressurizing chamber 11 does not collide with the periphery of the communication hole 1e, thereby making it possible to improve the durability of the plunger 2.

The high-pressure fuel supply pump 100 according to the above-described embodiment includes a discharge joint 12 attached to the pump body 1 on the downstream side of the pressurizing chamber 11 (pressurizing chamber). The relief valve 4 is inserted into the second chamber 1b from the discharge joint 12. This makes it possible to easily place the relief valve 4 in the second chamber 1b, thereby improving the workability in assembling the high-pressure fuel supply pump 100. In addition, it is not necessary to newly provide a hole for placing the relief valve 4 in the second chamber 1b in the pump body 1, making it possible to prevent the pump body 1 from having a complicated shape.

In the high-pressure fuel supply pump 100 according to the above-described embodiment, the moving direction of the valve portion 43 in the relief valve 4 is perpendicular to the direction in which the plunger 2 reciprocates. This makes it possible to prevent the second chamber 1b for placing the relief valve 4 from extending in the direction in which the plunger 2 reciprocates. As a result, the length of the pump body 1 in the direction in which the plunger 2 reciprocates can be shortened, thereby making it possible to downsize the pump body 1.

In addition, the high-pressure fuel supply pump 100 according to the above-described embodiment includes a discharge valve 8 disposed on the downstream side of the pressurizing chamber 11. The moving direction of the valve portion 82 in the discharge valve 8 is different from the moving direction of the valve portion 43 in the relief valve 4. The relief valve 4 is disposed at a position higher than the discharge valve 8 in the up-down direction in which the plunger 2 reciprocates. This makes it possible to prevent the discharge valve 8 and the relief valve 4 from interfering with each other even if they partially overlap each other in a direction perpendicular to the up-down direction. As a result, the space inside the pump body 1 can be effectively used, thereby downsizing the pump body 1.

In the high-pressure fuel supply pump 100 according to the embodiment described above, the pump body 1 is formed in a substantially columnar shape, and the center of the first chamber 1a coincides with the center of the pump body 1. The moving direction of the valve portion 82 in the discharge valve 8 is a first radial direction of the pump body 1. The moving direction of the valve portion 43 in the relief valve 4 is a second radial direction different from the first radial direction of the pump body 1. This makes it possible to position the discharge valve 8 and the relief valve 4 so as not to overlap each other in the moving direction of the plunger 2, so that the space inside the pump body 1 can be effectively used to downsize the pump body 1.

The pump body 1 of the high-pressure fuel supply pump 100 according to the embodiment described above includes a third chamber 1c communicating with the first chamber 1a and having a larger diameter than the first chamber 1a. A cylinder 6 through which the plunger 2 slidably penetrates is disposed in the third chamber 1c. As a result, an end surface of the cylinder 6 can abut on the step portion between the first chamber la and the third chamber 1c, thereby preventing the cylinder 6 from being displaced toward the first chamber 1a. The fuel having a high pressure in the pressurizing chamber 11 is prevented from leaking to the low pressure side by the contact surface pressure between the press-fitting portion (press-fitting surface) 6a or the corner portion 6b of the cylinder 6 and the third chamber 1c.

When the pressure in the pressurizing chamber 11 becomes high by operating the high-pressure fuel supply pump 100, the same pressure as that in the pressurizing chamber 11 is also applied onto the end surface of the cylinder 6. Due to this pressure, a force is generated in the cylinder 6 in a direction in which the cylinder 6 is pulled out of the third chamber 1c. This pulling-out force is received by the press-fitting portion 6a and the protruding portion 1x having the plastically deformed portion 1x1, thereby preventing the cylinder 6 from falling off. However, if the fuel pressure is further increased, excessive stress may be generated in the protruding portion 1x, and fatigue fracture may occur in the protruding portion 1x.

Therefore, in the present embodiment, as illustrated in FIG. 7, the pump body 1 has a shape in which a protruding portion 1x and a plastically deformed portion 1x1 are formed over the entire circumference around the center line (axis) of the cylinder 6. In this case, the protruding portion 1x and the plastically deformed portion 1x1 have an axisymmetric shape. Further, the cylinder corner portion 6 has an R shape, and the specific dimension of the R shape is about R0.3 to R0.5. However, the specific dimension of the R shape is not necessarily limited thereto, and may be set to another value depending on the situation. In addition, instead of the R shape, the cylinder corner portion 6 may be shaped to smoothly connect a surface (radial surface) 6f formed along the radial direction of the cylinder 6 and the press-fitting portion 6a, and have no discontinuous point in a region in contact with the protruding portion 1x. This makes it possible to suppress concentration of stress at one point in the protruding portion 1x having the plastically deformed portion 1x1. Note that the radial surface 6f is not limited to the direction perpendicular to the center line 1A, and may be inclined with respect to the direction perpendicular to the center line 1A.

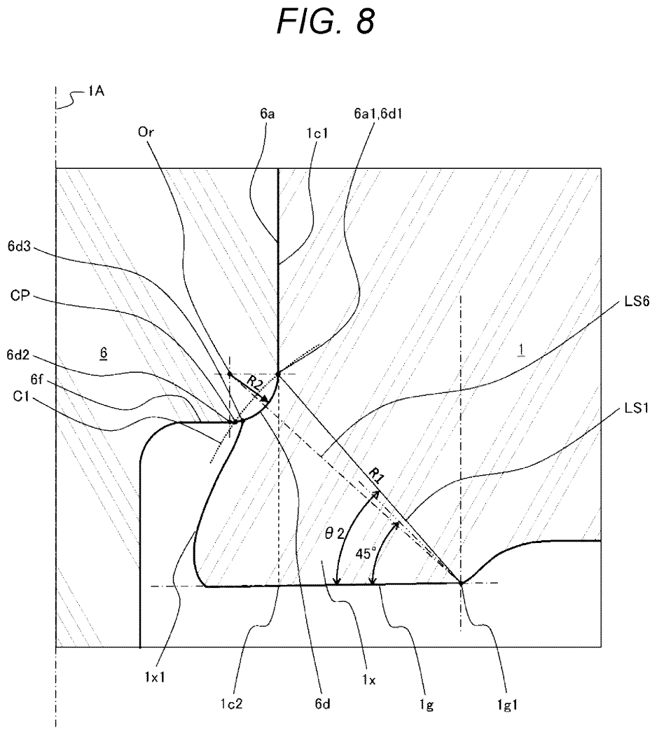

The high-pressure fuel supply pump 100 of the present embodiment has a two-member fixing structure that suppresses concentration of stress. The two-member fixing structure will be described with reference to FIG. 8.

FIG. 8 is an enlarged view of the protruding portion 1x after being plastically deformed of the high-pressure fuel supply pump 100 according to an embodiment of the present invention. FIG. 8 is a cross section including the center line 1A and parallel to the center line 1A.

In the present embodiment, the shape of the cylinder corner portion 6 that smoothly connects the radial surface 6f and the press-fitting portion 6a of the cylinder 6 will be described as a curved surface portion formed by a curved surface that is convex outward in the radial direction, including the R shape.

The fixing structure applied to the high-pressure fuel supply pump 100 of the present embodiment is a two-member fixing structure that fixes a first member (pump body) 1 having a cylindrical inner circumferential surface 1cl and a second member (cylinder) 6 having a cylindrical outer circumferential surface 6a. The second member (cylinder) 6 includes a curved surface portion 6d at one end 6a1 of the outer circumferential surface 6a in a direction (axial direction) along a center line 1A, the curved surface portion 6d being formed by a curved surface of which a diameter reduces so as to be convex outward in a radial direction as being away from the outer circumferential surface 6a along the center line 1A with the one end of the outer circumferential surface 6a as a start point 6d1. In a state where the second member (cylinder) 6 is fixed to the inner circumferential surface 1c1 of the first member (pump body) 1, the first member (pump body) 1 includes a pressed surface 1g formed by pressing a peripheral edge portion 1c2 of the inner circumferential surface 1c1 of the first member (pump body) 1, and a plastically deformed portion 1x1 plastically deformed inward of the outer circumferential surface 6a of the second member (cylinder) 6 in the radial direction.

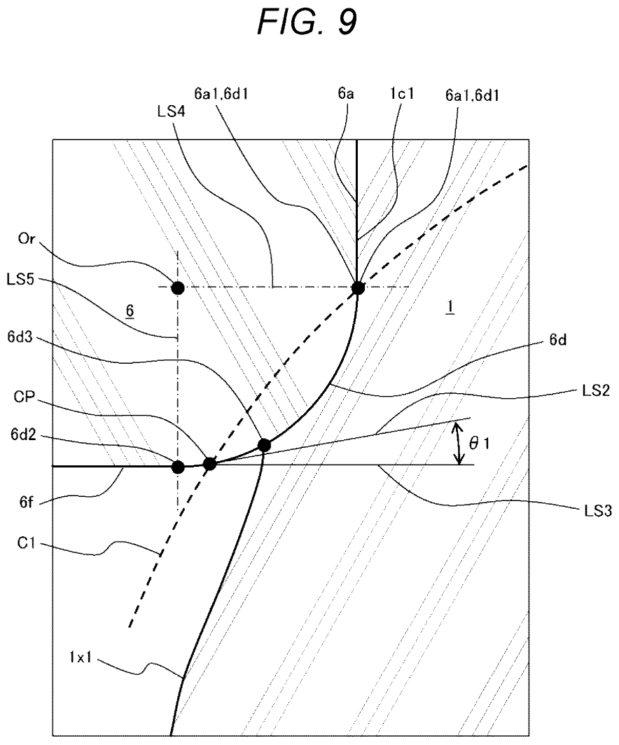

Here, the features of the pressed surface 1g pressed by the punch will be described with reference to FIG. 9. FIG. 9 is an enlarged view in which the vicinity of the plastically deformed portion 1x1 in FIG. 8 is enlarged. FIG. 9 is a cross section including the center line 1A and parallel to the center line 1A.

A circle C1 intersects with the curved surface portion 6d, when the circle C1 is drawn with a radius being a length R1 of a line segment LS1 connecting the start point 6d1 of the curved surface portion 6d and a radially outer end point 1g1 of the pressed surface 1g of the first member (pump body), while the radially outer end point 1g1 of the pressed surface 1g is the center of the circle C1. Then, an angle θ1 formed between a tangent line LS2 that is in contact with the curved surface portion 6d at an intersection point CP between the circle C1 and the curved surface portion 6d and a line (line segment) LS3 perpendicular to the center line 1A is larger than 0°.

Note that the radially outer end point of the curved surface portion 6d is denoted by 6d1, and the radially inner end point of the curved surface portion 6d is denoted by 6d2. That is, the curved surface portion 6d is formed between 6d1 and 6d2. Note that an R portion (R-shaped portion) having a radius R2 is formed in a range where the central angle is 90°, a line segment LS4 connecting the center Or of the R portion and 6d1 is perpendicular to the center line 1A (see FIG. 8), and a line segment LS5 connecting the center Or of the R-shaped portion and 6 d2 is parallel to the center line 1A.

A contact start point at which the protruding portion 1x of the pump body 1 and the cylinder corner portion 6b start to come into contact with each other is denoted by 6d3. The contact start point 6d3 is a portion located on an innermost side (innermost circumferential side) in the radial direction of a region where the protruding portion 1x and the cylinder corner portion 6b are in contact with each other. The curved surface portion (R portion) 6d is in contact with the protruding portion 1x in the entire region on the pressurizing chamber 11 side from the contact start point 6d3, and there is no gap. In addition, θ1>0° is satisfied, θ1 being an angle between the tangent line LS2 in contact with the intersection point CP and the line LS3 perpendicular to the axial direction of the plunger 2.

That is, the two-member fixing structure applied to the high-pressure fuel supply pump 100 of the present embodiment is a two-member fixing structure that fixes a first member (pump body) 1 having a cylindrical inner circumferential surface 1c1 and a second member (cylinder) having a cylindrical outer circumferential surface 6a, in which
the second member (cylinder) 6 includes a curved surface portion 6d at one end 6a1 of the outer circumferential surface 6a in a direction (axial direction) along a center line 1A, the curved surface portion 6d being formed by a curved surface of which a diameter reduces so as to be convex outward in a radial direction as being away from the outer circumferential surface 6a along the center line 1A with the one end 6d1 of the outer circumferential surface 6a as a start point 6d1, in a state where the second member (cylinder) 6 is fixed to the inner circumferential surface 1c1 of the first member (pump body) 1, the first member (pump body) 1 includes a pressed surface 1g formed by pressing a peripheral edge portion 1c2 of the inner circumferential surface 1c1 of the first member (pump body) 1, and a plastically deformed portion 1x1 plastically deformed inward of the outer circumferential surface 6a of the second member (cylinder) 6 in the radial direction,
a circle C1 intersects with the curved surface portion 6d, when the circle C1 is drawn with a radius being a length R1 of a line segment LS1 connecting the start point 6d1 of the curved surface portion 6d and a radially outer end point 1g1 of the pressed surface 1g of the first member (pump body), while the radially outer end point 1g1 of the pressed surface 1g is the center of the circle C1, and
an angle θ1 formed between a tangent line LS2 that is in contact with the curved surface portion 6d at an intersection point CP between the circle C1 and the curved surface portion 6d and a line LS 3 perpendicular to the center line 1A is larger than 0°.

In this case, the contact start point 6d3 is located on the radially outer side (outer circumferential side) with respect to the radially inner end point 6d2 of the curved surface portion 6d. That is, in the two-member fixing structure of the present embodiment, the contact start point 6d3 at which the plastically deformed portion 1x1 of the first member (pump body) 1 and the second member (cylinder) 6 start to come into contact with each other is located radially outside the radially inner end point 6d2 of the curved surface portion 6d.

If the contact start point 6d3 is disposed immediately below the radially inner end point 6d2, that is, at the position of the radially inner end point 6 d2, 01 becomes 0°, a large bending moment is generated in the plastically deformed portion 1x1 of the protruding portion 1x, and stress is likely to concentrate.

In the present embodiment, since the contact start point 6d3 is located on the radially outer side (outer circumferential side) with respect to the radially inner end point 6d2 of the curved surface portion 6d, the bending moment generated in the plastically deformed portion 1x1 of the protruding portion 1x can be reduced. That is, by setting θ>0°, it is difficult to generate a large bending moment in the plastically deformed portion 1x1 of the protruding portion 1x, and it is possible to avoid concentration of stress at one point. As a result, in the present embodiment, even if the system fuel pressure becomes high, for example, 50 MPa, the protruding portion 1x can be shaped so as not to cause fatigue fracture.

Referring back to FIG. 7, the description will be given. In order to achieve θ1>0°, θ2 is preferably set in a range of θ>45°, θ2 being an angle formed by the line segment LS1 and the pressed surface 1g. That is, the angle θ2 formed by the line segment LS1 connecting the starting point 6d1 and the radially outer end point 1g1 of the pressed surface 1g and the pressed surface 1g is larger than 45°. In a caulking stroke, a load is applied to the pressed surface 1g to deform the protruding portion 1x, but the deformation of the protruding portion 1x is suppressed by setting θ2>45°, so that θ1>0° can be satisfied.

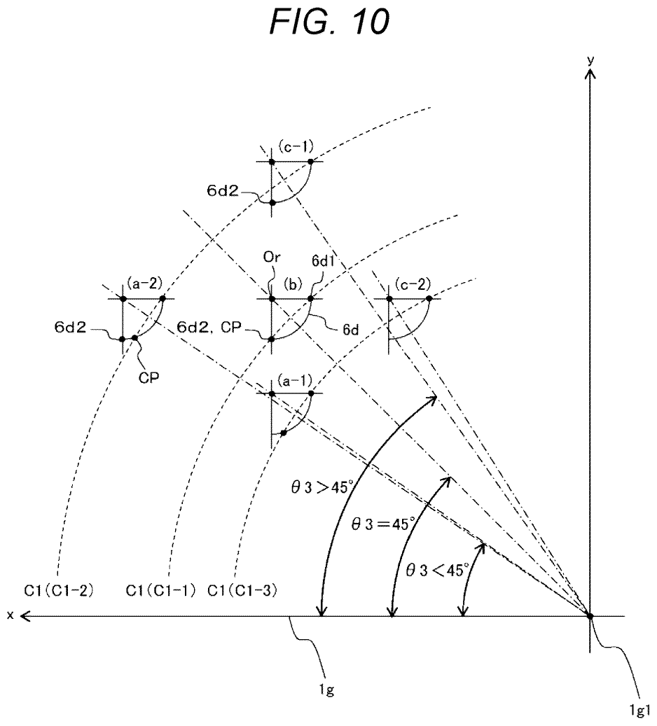

The arrangement of the R portion will be described with reference to FIG. 10. FIG. 10 is a diagram for explaining a relationship at an intersection between each of the circles C1-1, C1-2, and C1-3 with the center being the radially outer end point 1g1 of the pressed surface 1g and the curved surface portion according to an embodiment of the present invention.

Each of (a-1), (a-2), (b), (c-1), and (c-2) shows a case where the relative positional relationship between the curved surface portion (R portion) 6d and the radially outer end point 1g1 of the pressed surface 1g is different. In the drawing, 6d denotes a surface portion, 6d1 denotes a radially outer end point (start point) of the curved surface portion 6d, 6d2 denotes a radially inner end point of the curved surface portion 6d, Or denotes the center of the curved surface portion 6d, and CP denotes an intersection point between the circle C1 and the curved surface portion 6d. In order to avoid the complication of the drawings, reference signs are illustrated only in some of the drawings, but the reference signs are common to (a-1), (a-2), (b), (c-1), and (c-2).

A plurality of alternate long and short dash lines are line segments each connecting the center Or of the curved surface portion 6d and the radially outer end point 1g1 of the pressed surface 1 g. θ3 denotes an angle between the alternate long and short dash line and the pressed surface 1g. (b) shows a case where the center Or of the curved surface portion 6d is on an alternate long and short dash line satisfying θ3=45°. Each of (a-1) and (a-2) shows a case where the center Or of the curved surface portion 6d is on an alternate long and short dash line satisfying θ3 <45°. Each of (c- 1) and (c-2) shows a case where the center Or of the curved surface portion 6d is on an alternate long and short dash line satisfying θ3>45°.

In (b), the above-described circle C1 passes through the radially inner end point 6d2, and the above-described relationship of θ1>0° is not satisfied.
In each of (a-1) and (a-2), the above-described circle C1 (each of C1-1 and C1-2) intersects with the curved surface portion 6d, and the above-described relationship of θ1>0° is satisfied.
In each of (c-1) and (c-2), the above-described circle C1 (each of C1-1 and C1-2) passes radially inward of the radially inner end point 6d2, and the above-described relationship of θ1>0° is not satisfied.

As described above, in order to satisfy the above-described relationship of θ1>0°, the angle θ3 between the line segment LS6 (see FIG. 8), which connects the center Or of the curved surface portion 6d and the radially outer end point 1g1 of the pressed surface 1g, and the pressed surface 1g needs to be 45° or less (θ3<45°). In this case as well, it is preferable to set θ2 in the range of θ2>45°.

That is, the two-member fixing structure of the present embodiment is a two-member fixing structure that fixes a first member 1 having a cylindrical inner circumferential surface 1c1 and a second member 6 having a cylindrical outer circumferential surface 6a, in which
the second member 6 includes a curved surface portion 6d at one end 6a1 of the outer circumferential surface 6a in a direction along a center line 1A, the curved surface portion 6d being formed by a curved surface of which a diameter reduces so as to be convex outward in a radial direction as being away from the outer circumferential surface 6a along the center line 1A with the one end 6a1 of the outer circumferential surface 6a as a start point 6d1,
in a state where the second member 6 is fixed to the inner circumferential surface 1c1 of the first member 1, the first member 1 includes a pressed surface 1g formed by pressing a peripheral edge portion of the inner circumferential surface 1c1 of the first member 1, and a plastically deformed portion 1x1 plastically deformed inward of the outer circumferential surface 6a of the second member 6 in the radial direction, and
an angle θ3 formed by a line segment LS6 connecting the center Or of a radius of the curved surface portion 6d and the radially outer end point 1g1 of the pressed surface 1g of the first member 1 and a line perpendicular to the center line 1A (the pressed surface 1g in the present embodiment) is set to be smaller than 0°.

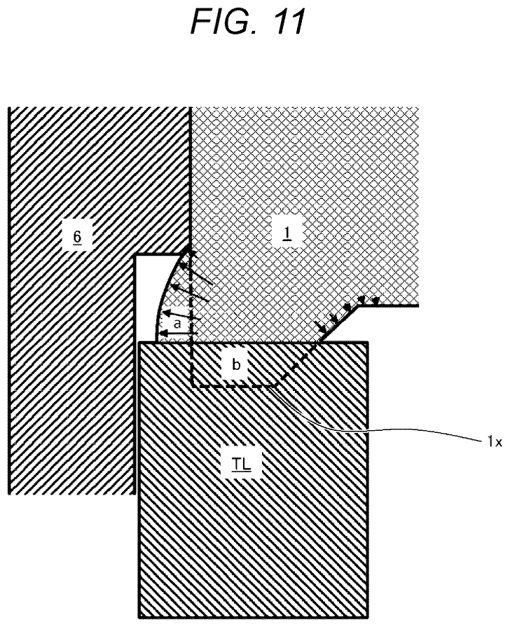

FIG. 11 is a conceptual diagram illustrating a two-member fixing structure according to an embodiment of the present invention.
The pump body 1 is made of a material softer than a punch TL that presses the cylinder 6 and the pressed portion 1g. By pressing the protruding portion 1x of the pump body 1, which is indicated by a broken line, with the punch TL, the material of portion b plastically flows as indicated by an arrow in the drawing. At this time, since the material of portion b radially flows in a direction along an escape route, the material of portion b mostly flows into portion a.

The material flowing from portion b to portion a has nowhere to go toward the pump body 1 and the press-fitting portion of the cylinder 6, and the flow is stopped. the pressing by the punch TL is continued even after the flow is stopped, the flowing material reaches the radial surface 6f (see FIG. 9) beyond the curved surface portion 6d. Therefore, the various conditions described above, for example, θ1>0°, are not satisfied. In order to satisfy the various conditions described above, it is necessary to accurately grasp and accurately control the amount of the plastically flowing material. The amount of material that needs to plastically flow can be determined experimentally. However, when the relative positional relationship between the pump body 1 and the cylinder 6 changes during manufacturing, the amount of the plastically flowing material cannot be accurately controlled.

In the present embodiment, the pump body 1 and the cylinder 6 are fixed by press fitting before the protruding portion 1x is pressed by the punch TL. That is, the second member 6 and the first member 1 are fixed to each other by press-fitting the outer circumferential surface 6a of the second member (cylinder) 6 into the inner circumferential surface 1c1 of the first member (pump body) 1. This makes it possible to suppress a change in relative positional relationship between the pump body 1 and the cylinder 6, and the amount of the plastically flowing material can be accurately controlled. By satisfying the various conditions described above, it is possible to provide a two-member fixing structure and a high-pressure fuel supply pump in which the protruding portion 1x is less likely to cause fatigue fracture.

The embodiments of the two-member fixing structure and the high-pressure fuel supply pump according to the present invention have been described above, including their functions and effects. However, the two-member fixing structure and the fuel pump according to the present invention are not limited to the above-described embodiments, and various modifications can be made without departing from the gist of the invention set forth in the claims. In addition, the above-described embodiments have been described in detail in order to describe the present invention in an easy-to-understand manner, and the two-member fixing structure and the high-pressure fuel supply pump according to the present invention are not necessarily limited to having all the configurations described above.

### REFERENCE SIGNS LIST

100 high-pressure fuel supply pump
1A center line
1 first member (pump body)
1c1 inner circumferential surface of first member (pump body) 1
1c2 peripheral edge portion of inner circumferential surface
1c1 of first member (pump body) 1
1g pressed surface
1g1 radially outer end point of pressed surface 1g
1x1 plastically deformed portion
6 second member (cylinder)
6a outer circumferential surface of second member (cylinder) 6
6al one end of outer circumferential surface 6a of second member (cylinder) 6
6d curved surface portion
6d1 start point of curved surface portion 6d
6d2 radially inner end point of curved surface portion 6d
6d3 contact start point at which plastically deformed portion
1x1 and second member (cylinder) 6 start to come into contact with each other
C1 circle with its center being radially outer end point 1g1
CP intersection point between circle C1 and curved surface portion 6d
LS1 line segment connecting start point 6d1 of curved surface portion 6d and radially outer end point 1g1 of pressed surface 1g
LS2 tangential line in contact with curved surface portion 6d at intersection point CP
LS6 line segment connecting center Or of curved surface portion 6d and radially outer end point 1g1 of pressed surface 1g of first member 1
Or center of radius of curved surface portion 6d
θ1 angle between line perpendicular to center line 1A and tangential line LS2
θ2 angle formed by line segment LS1 and pressed surface 1g
θ3 angle formed between line segment LS6 and line perpendicular to center line 1A

1. A two-member fixing structure that fixes a first member having a cylindrical inner circumferential surface and a second member having a cylindrical outer circumferential surface, wherein
the second member includes a curved surface portion at one end of the outer circumferential surface in a direction along a center line, the curved surface portion being formed by a curved surface of which a diameter reduces so as to be convex outward in a radial direction as being away from the outer circumferential surface along the center line with the one end of the outer circumferential surface as a start point,
in a state where the second member is fixed to the inner circumferential surface of the first member, the first member includes a pressed surface formed by pressing a peripheral edge portion of the inner circumferential surface of the first member, and a plastically deformed portion plastically deformed inward of the outer circumferential surface of the second member in the radial direction,
a circle intersects with the curved surface portion, when the circle is drawn with a radius being a length of a line segment connecting the start point of the curved surface portion and a radially outer end point of the pressed surface of the first member, while the radially outer end point of the pressed surface is the center of the circle, and
an angle formed between a tangent line that is in contact with the curved surface portion at an intersection point between the circle and the curved surface portion and a line perpendicular to the center line is larger than 0°.

2. The two-member fixing structure according to claim 1, wherein
an angle formed by the pressed surface and the line segment connecting the start point and the radially outer end point of the pressed surface is larger than 45°.

3. The two-member fixing structure according to claim 1, wherein
the second member and the first member are fixed to each other by press-fitting the outer circumferential surface of the second member into the inner circumferential surface of the first member.

4. The two-member fixing structure according to claim 1, wherein
a contact start point at which the plastically deformed portion of the first member and the second member start to come into contact each other is located radially outside a radially inner end point of the curved surface portion.

5. A two-member fixing structure that fixes a first member having a cylindrical inner circumferential surface and a second member having a cylindrical outer circumferential surface, wherein
the second member includes a curved surface portion at one end of the outer circumferential surface in a direction along a center line, the curved surface portion being formed by a curved surface of which a diameter reduces so as to be convex outward in a radial direction as being away from the outer circumferential surface along the center line with the one end of the outer circumferential surface as a start point,
in a state where the second member is fixed to the inner circumferential surface of the first member, the first member includes a pressed surface formed by pressing a peripheral edge portion of the inner circumferential surface of the first member, and a plastically deformed portion plastically deformed inward of the outer circumferential surface of the second member in the radial direction, and
an angle formed by a line segment connecting the center of a radius of the curved surface portion and the radially outer end point of the pressed surface of the first member and a line perpendicular to the center line is set to be smaller than 0°.

6. A high-pressure fuel supply pump comprising a pump body and a cylinder, wherein
the pump body and the cylinder are fixed to each other by the two-member fixing structure according to claim 1, with the pump body being the first member and the cylinder being the second member.

7. A high-pressure fuel supply pump comprising a pump body and a cylinder wherein
the pump body and the cylinder are fixed to each other by the two-member fixing structure according to claim 5, with the pump body being the first member and the cylinder being the second member.
